(19) United States
(12) Patent Application Publication
(10) Pub. No.: US 2025/0267675 A1
(43) Pub. Date: Aug. 21, 2025

(54) METHOD AND APPARATUS FOR SOUNDING REFERENCE SIGNAL ENHANCEMENTS

(71) Applicant: Apple Inc., Cupertino, CA (US)

(72) Inventors: Haitong Sun, Cupertino, CA (US); Dawei Zhang, Saratoga, CA (US); Hong He, San Jose, CA (US); Chunxuan Ye, San Diego, CA (US); Wei Zeng, Saratoga, CA (US); Jie Cui, San Jose, CA (US); Ankit Bhamri, Bad Nauheim (DE)

(21) Appl. No.: 19/054,048

(22) Filed: Feb. 14, 2025

Related U.S. Application Data
(60) Provisional application No. 63/554,797, filed on Feb. 16, 2024.

(51) Int. Cl. H04W 72/231; H04L 1/1607; H04L 5/00; H04W 72/0453

(52) U.S. Cl. CPC H04W 72/231; H04L 1/1614; H04L 5/0051; H04W 72/0453

(57) ABSTRACT

A baseband processor, user equipment (UE), and network device are described. The baseband processor and UE can perform receiving control signaling that indicates a sounding reference signal (SRS) configuration of a set of SRS ports associated with a set of antenna ports, where the UE can perform antenna switching using the antenna ports. The SRS configuration identifies at least a first and second SRS resources. The baseband process can provide SRSs for transmission from the UE using the first and second SRS resources, and transmit a control message that includes power headroom reports that indicate first and second power values for the first and second SRS resources, for example indicating an antenna imbalance at the UE. Examples are further described for a UE to maintain a same phase for SRS transmissions during a window, and flexibly SRS rate match around uplink shared channel signals.

### CROSS REFERENCE TO RELATED APPLICATION

This application is a nonprovisional and claims the benefit under 35 U.S.C. § 119 (e) of U.S. Provisional Patent Application No. 63/554,797, filed Feb. 16, 2024, the contents of which are incorporated herein by reference as if fully disclosed herein.

### TECHNICAL FIELD

This application relates generally to wireless communication systems, including systems, apparatuses, and methods for method and apparatus for sounding reference signal enhancements.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIGS. 2A-2D show example media access control (MAC) control elements (CE), according to one or more aspects described herein.

FIG. 3A-3C show example MAC CEs, according to one or more aspects described herein.

FIG. 4 shows an example signaling diagram, according to one or more aspects described herein.

FIGS. 5A-5B show example resource allocations, according to one or more aspects described herein.

FIG. 6 shows an example method of wireless communication by a UE, according to one or more aspects described herein.

FIG. 7 shows another example method of wireless communication by a network device, according to one or more aspects described herein.

FIG. 8 shows another example method of wireless communication by a UE, according to one or more aspects described herein.

FIG. 9 shows another example method of wireless communication by a network device, according to one or more aspects described herein.

FIG. 10 shows another example method of wireless communication by a UE, according to one or more aspects described herein.

FIG. 11 shows another example method of wireless communication by a network device, according to one or more aspects described herein.

FIG. 12 illustrates an example architecture of a wireless communication system, according to embodiments described herein.

FIG. 13 illustrates an example system for performing signaling between a wireless device and a network device, according to embodiments described herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In wireless communications (including in 5G/New Radio (NR)), a sounding reference signal (SRS) serves as a mechanism for uplink channel quality measurement and sounding. The UE transmits SRS signals to provide feedback to a network entity serving the UE (e.g., a base station or gNB) regarding the quality of the communication channel. In some cases (e.g., for time division duplexing (TDD) deployments), the network entity can utilize the channel estimation result from SRS both for uplink scheduling as well as for downlink scheduling based on channel reciprocity in TDD. SRS signals are typically transmitted periodically by the UE, allowing the network entity to continually monitor and adapt to changing channel conditions. The SRS can be used by the network entity to determine channel conditions, such as signal strength, propagation delay, and frequency response. The network entity can then estimate parameters used for beamforming, power control, scheduling, and resource allocation. Additionally, SRS assists in determining the optimal precoding matrix and beamforming weights, improving the overall spectral efficiency and throughput of the system.

One or both of a UE and a network entity may operate using multiple ports for uplink, for downlink, or both. Multi-port operations, and especially uplink operations, rely on SRS signal transmission by the UE. Resources (e.g., time-frequency resources) used for SRS transmission by the UE are configured in units of SRS resources, such that an SRS resource set may be configured with multiple different SRS resources.

An SRS resource set can have one of a set of usages (e.g., use cases) for the SRS resource set, including codebook, non-codebook, beam management, and antenna switching. The codebook usage is for codebook-based physical uplink shared channel (PUSCH) operation, where each SRS resource can be associated with one SRS port of the UE, or multiple SRS ports of the UE. For PUSCH, the network schedules an SRS resource indicator (SRI) to select one of the SRS resources as well as a transmit precoding matrix indicator (TPMI) corresponding to the SRS resource indicated by the SRI. For the non-codebook usage, each SRS resource is associated with a single SRS port. For PUSCH, the network schedules an SRI to select one or multiple of the SRS resources. For the beam management usage, applicable to uplink beam management (e.g., analog beam sweeping), each SRS resource is associated with a single SRS port. For the antenna switching usage, downlink channel acquisition is based on channel reciprocity. Each SRS resource is associated with one or more SRS ports, for example such that there are at least as many receive ports as transmit ports for a multiple-input multiple-output (MIMO) radio configuration of the UE, such that for xTyR, y≥x (e.g., 2T2R, 2T4R, 4T4R, 4T8R, 8T8R).

According to some techniques, SRS can be transmitted in the last six symbols of each slot, repeated in up to four symbols, and utilize a comb size of two (SRS resources in every other subcarrier) or four (every fourth subcarrier for SRS). According to further techniques, SRS can be transmitted in any symbol in a slot, use repetition of eight or twelve symbols, and use a comb size of two, four, or eight. According to yet further techniques, SRS can be transmitted based on an aperiodic trigger, use resource block-level partial frequency sounding (RPFS), use repetition of up to ten or fourteen symbols, and use a comb size of eight with four ports. In still further techniques, SRS ports can be time division multiplexed (TDM), and there may be up to eight SRS ports. SRS resources may also use a comb offset and perform cyclic shift hopping for SRS.

As the number of transmit and receive ports increases, such as for antenna switching, and the quantity of SRS resources and SRS ports increases, challenges exist for SRS and SRS resource management and design. For example, transmit and receive chains may experience different insertion losses (e.g., due to differences in power amplifiers or other components of a radio frequency subsystem), channel conditions may fluctuate over time, or a UE or network device may not be able to successfully handle more complex SRS resource configurations due to hardware limitations.

As further discussed herein, improved techniques are described that support SRS enhancements, including to support SRS antenna imbalance reporting, SRS transmission using phase continuity, and flexible SRS rate matching.

According to one or more embodiments described herein, a UE may be configured to perform antenna switching using a set of antenna ports. The network (e.g., via a network entity) may transmit to a baseband processor (e.g., via the UE) SRS configuration signaling for a set of SRS ports that are associated with the set of antenna ports. The SRS configuration can identify multiple SRS resources, including at least a first SRS resource and a second SRS resource. The baseband processor can provide SRS signals for transmission (e.g., via the antenna ports of the UE) using the first SRS resource and the second SRS resource. The baseband processor can also transmit a control message that includes one or more power headroom reports that indicate a first power value for the first SRS resource and a second power value of the second SRS resource. The difference between the first power value and the second power value can indicate an insertion loss difference between different antenna ports.

According to one or more embodiments, a baseband processor (e.g., via the UE) can transmit, to a network entity, control signaling indicating a capability of the UE to maintain a same phase for SRS transmissions during a phase continuity window. In response to the UE capability, the network (e.g., via the network entity) can configure the phase continuity window, for example by providing an indication of a time duration of the phase continuity window.

According to one or more embodiments, a baseband processor (e.g., via the UE) can receive control signaling that indicates the use of discrete Fourier transform spread orthogonal frequency division multiplexing (DFT-s-OFDM) for an uplink shared channel (e.g., a PUSCH) in a radio frequency spectrum band that includes a number of frequency resources, such as physical resource block (PRBs). The network device can then provide downlink control information (DCI) signaling that includes a bitmap (e.g., as a frequency domain resource allocation (FDRA)) to allocate some of the frequency resources (e.g., PRBs) to the uplink shared channel, while others of the frequency resources (e.g., PRBs) are used for SRSs. The UE can then transmit the PUSCH and SRS on the indicated frequency resources.

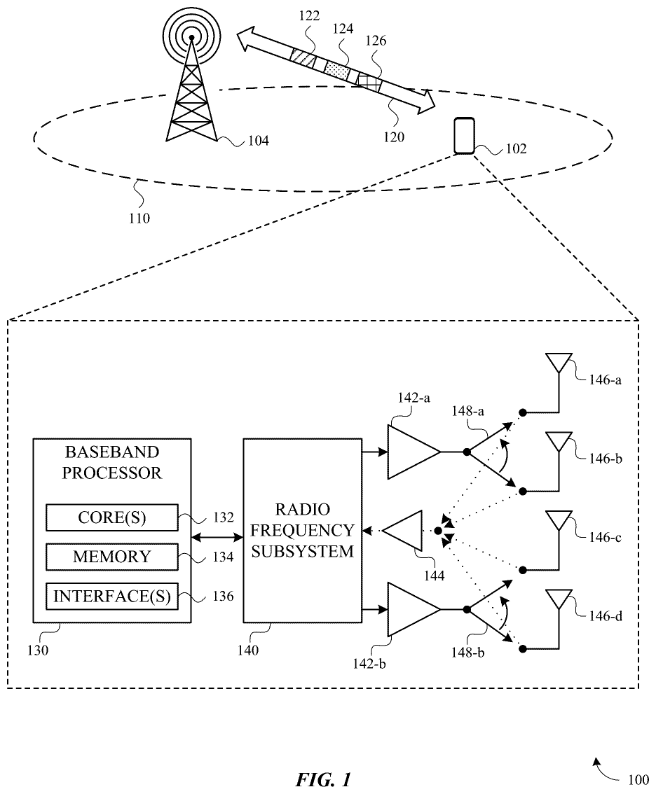

FIG. 1 shows an example wireless communications system 100, according to one or more aspects described herein. In one or more embodiments, wireless communications system 100 supports one or more aspects of methods and apparatus for SRS enhancements, as further described herein.

Wireless communications system 100 includes at least one or more a UE 102 and one or more of a network device 104. In one or more embodiments described herein, the network device 104 is a NG RAN cell, and has a coverage area 110. In some embodiments, the network device 104 may be one of multiple network devices (e.g., NG RANs) that make up the cellular network with which the UE 102 has established a connection, such as wireless communication link 120.

In one or more embodiments, UE 102 includes a baseband processor 130 to manage radio functions and components of the UE 102. In some embodiments, baseband processor 130 includes one or more cores 132 coupled with memory 134 and one or more interfaces 136, and other components, circuitry, or firmware to facilitate or otherwise support wireless communications by a UE 102, including performing one or more operations further described herein to support SRS enhancements. Core(s) 132 (which may also be referred to as, for example, a processor, processor core, processing unit, engine, or accelerator) of the baseband processor 130 can include one or more of a wireless communication processor, a central processing unit, a graphical processing unit, an artificial intelligence engine, a security engine, an image signal processor, a sensing system, a location system, or a display processor. One or more wireless communications processors (e.g., modems) may include support for cellular communications (e.g., 5G/NR, 4G/LTE) or wireless local area network (WLAN) communications (e.g., Wi-Fi® or Bluetooth™).

Baseband processor 130 is communicatively coupled with a radio frequency (RF) subsystem 140. The RF subsystem 140 is coupled with at least one power amplifier 142 (for transmission) and at least one low noise amplifier 144 (for reception), and a set of one or more antennas 146. The RF subsystem 140 may include one or more transceivers (e.g., of an RF integrated circuit (RFIC)) and one or more components of an RF front-end. In some examples, the at least one power amplifier 142 and the at least one low noise amplifier 144 are illustrated as separate from the RF subsystem 140, but may be considered as part of the RF subsystem 140, for example as part of the RF front-end of UE 102.

In the example illustrated with reference to wireless communications system 100, UE 102 has four antennas 146 (146-a, 146-b, 146-c, 146-d), two power amplifiers 142 (142-a and 142-b), and one low noise amplifier 144. A first switch 148-a may be utilized to switch a first power amplifier 142-a between a first antenna 146-a and a second antenna 146-b for transmission. A second switch 148-b may be utilized to switch a second power amplifier 142-b between a third antenna 146-c and a fourth antenna 146-d for transmission. For reception, all four antennas 146 can be input to a receive chain of the RF subsystem 140 via the low noise amplifier 144. In this example of wireless communications system 100, the MIMO radio configuration uses antenna switching, and is 2T4R with antenna switching.

In one or more embodiments, for SRS with antenna switching where xTyR, y≥x, there are/x SRS resources used to acquire a downlink channel for y receive antenna ports, where each SRS resource has x SRS ports. For example, in the case of 2T4R with antenna switching, there are two SRS resources used to acquire a downlink channel for the four receive antenna ports, and each SRS resource has 2 SRS ports. Due to insertion loss differences between different transmit (Tx) and receive (Rx) pairs, some Tx and Rx pairs may experience higher insertion loss compared to other Tx and Rx pairs. As a result, downlink channel acquisition may be impacted, for example especially when downlink and uplink imbalance is similar.

In one or more embodiments described herein, a power headroom (PHR) report supports reporting of an insertion loss difference for SRS, for example when antenna switching is used. In one or more embodiments, the UE 102 has a set of SRS ports for a set of antenna ports of the UE 102 (e.g., the antenna ports using the antennas 146), and the UE 102 uses antenna switching. The baseband processor 130 (e.g., via antennas 146 and the RF subsystem 140 of the UE 102) receives control signaling 122 that indicates an SRS configuration for the SRS ports, where the SRS configuration identifies SRS resources, for example at least a first SRS resource and a second SRS resource. In one example, four antenna ports may be associated with the four antennas 146, respectively. As such, the first SRS resource may be associated with the first antenna 146-a and the third antenna 146-c, and the second SRS resource may be associated with the second antenna 146-b and the fourth antenna 146-d.

The baseband processor 130 provides SRS signals 124 for transmission via the antenna ports (e.g., via the RF subsystem 140 and antennas 146 of the UE 102) using the first set of SRS resources and the second set of SRS resources. In one or more embodiments, each set of SRS resources are time-frequency resources within an orthogonal frequency division multiplexing (OFDM) resource grid, as configured for use by the UE 102 via the received SRS configuration.

The baseband processor 130 then may determine or otherwise identify a first power value for the first SRS resource and a second power value for the second SRS resource. In some embodiments, the difference between the first power value and the second power value indicates the insertion loss difference between different antenna ports of the plurality of antenna ports. The first power value may be based on the insertion loss for antenna ports associated with antenna 146-a and antenna 146-b, for example due to losses of components in the transmit chain of the RF subsystem 140 (including power amplifier 142-a) associated with antenna 146-a and antenna 146-b. The second power value may be based on the insertion loss for antenna ports associated with antenna 146-c and antenna 146-d, for example due to losses of components in the transmit chain of the RF subsystem 140 (including power amplifier 142-b) associated with antenna 146-c and antenna 146-d.

The baseband processor 130 (e.g., via the RF subsystem 140 and antennas 146 of the UE 102) then transmits a control message 126 that includes one or more PHR reports that indicate the first power value for the first SRS resource and the second power value for the second SRS resource. As further described herein, the PHR report may be different from existing PHR report types and variations. Existing PHR report types include a Type 1 PHR report that is used to report PHR with reference to a PUSCH transmission; a Type 2 PHR report that is used to report PHR with reference to a secondary primary cell (SpCell) of a base station; and a Type 3 PHR report that is used to report PHR with reference to an SRS transmission.

PHR is typically reported using a media access control (MAC) control element (CE). Six types of MAC CEs include a single entry PHR MAC CE, multiple entry PHR MAC CE, enhanced single entry PHR MAC CE, enhanced multiple entry PHR MAC CE, enhanced single entry PHR for multiple transmission reception point (TRP) MAC CE, and enhanced multiple entry PHR for multiple TRP MAC CE. In some embodiments, for PHR report enhancements to support a UE 102 to report the insertion loss difference for SRS with antenna switching, the UE 102 may be configured (e.g., by the network via network device 104) to report only the enhanced Type 3 PHR in the MAC-CE.

According to one or more embodiments, a PHR report that indicate a first power value for the first SRS resource and a second power value for the second SRS resource are an enhanced version of a Type 3 PHR report. In some embodiments, the PHR report can report different PHR for different SRS resources. A first power value (a first PHR) can be reported for the first SRS resource, and a second power value (a second PHR) can be reported for the second SRS resource. In some embodiments, a same PHR can be assumed to apply for all SRS ports in the same SRS port. For example, the first power value can be reported for the first SRS resource for all the SRS ports that are associated with that SRS resource. In the example of the UE 102 operating as 2T4R with antenna switching (further described herein), two PHR values can be reported, one power value for the first SRS resources and a second power value for the second SRS resources.

In some embodiments, the PHR report can report different PHR values for different SRS resources as well as different SRS ports. For example, the first power value can be for a first SRS port of the first SRS resource, and another power value can be reported as a PHR for a second SRS port of the first SRS resource. In the example of the UE 102 operating as 2T4R with antenna switching (further described herein), four PHR values can be reported, two power values for the first SRS resources (for the first and second SRS ports) and two power values for the second SRS resources (for the third and fourth SRS ports).

In one or more embodiments, multiple PHRs can be reported in a same MAC CE. In some embodiments, radio resource control (RRC) signaling can convey the multiple PHRs, such as in a UE assistance information message.

In one or more embodiments, a MAC CE for a PHR report includes a power headroom (PH), a maximum transmission power (P_{CMAX}), and a maximum permissible exposure (MPE) (which is a maximum transmission power reduction (P-MPR) due to MPE). A power backoff bit (P) may optionally be included to indicate that the MAC entity applies power backoff due to power management. Reserved bits (R) may also be included. The MAC CE includes a quantity of octets that may vary depending on the particular MAC CE format, as further described herein.

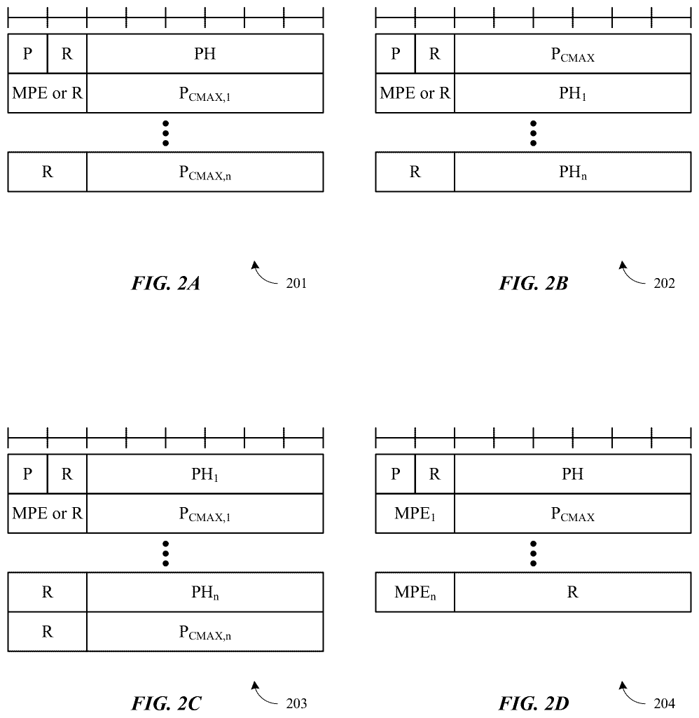

FIG. 2A shows an example MAC CE 201, according to one or more aspects described herein. In one or more embodiments, MAC CE 201 supports one or more aspects of method and apparatus for SRS enhancements, as further described herein. In some embodiments, MAC CE 201 is an example MAC CE where multiple P_{CMAX} are reported for different SRS resource/SRS port combinations, and a single PHR is reported. In one or more embodiments, MAC CE 201 is an example of a PHR report that indicates a first maximum transmission power for the first SRS resource, a second maximum transmission power for the second SRS resource, and a single power headroom value for both the first SRS resource and the second SRS resource. MAC CE 201 includes a P_{CMAX,1} (a first maximum transmission power) and can include any quantity of additional maximum transmission powers, up to P_{CMAX,n}, for a total of n maximum transmission powers. For the example of a second maximum transmission power, the MAC CE 201 may thus include three octets, and includes P_{CMAX,1} (a first maximum transmission power), P_{CMAX,2} (a second maximum transmission power), and a single PH value. MPE may be optionally included or omitted and two R bits included instead.

FIG. 2B shows an example MAC CE 202, according to one or more aspects described herein. In one or more embodiments, MAC CE 202 supports one or more aspects of methods and apparatus for SRS enhancements, as further described herein. In some embodiments, MAC CE 202 is an example MAC CE where multiple PH are reported for different SRS resource/SRS port combinations, and a single P_{CMAX} is reported. In one or more embodiments, MAC CE 202 is an example of a PHR report that indicates a first power headroom value for the first SRS resource, a second power headroom value for the second SRS resource, and a single maximum transmission power for both the first SRS resource and the second SRS resource. MAC CE 202 includes a PH₁ (a first power headroom value) and can include any quantity of additional power headroom values, up to PHₙ, for a total of n power headroom values. For the example of a second power headroom value, the MAC CE 202 may thus include three octets, and includes PH₁ (a first power headroom value), PH₂ (a second power headroom value), and a single P_{CMAX} (maximum transmission power value). MPE may be optionally included, or omitted and two R bits included instead.

FIG. 2C shows an example MAC CE 203, according to one or more aspects described herein. In one or more embodiments, MAC CE 203 supports one or more aspects of methods and apparatus for SRS enhancements, as further described herein. In some embodiments, MAC CE 203 is an example MAC CE where both multiple PH and P_{CMAX} are reported for different SRS resource/SRS port combinations. In one or more embodiments, MAC CE 203 is an example of a PHR report that indicates a first power headroom value and a first maximum transmission power for the first SRS resource, and indicates a second power headroom value and a second maximum transmission power for the second SRS resource. MAC CE 203 includes both a PH₁ (a first power headroom value) and a P_{CMAX,1} (a first maximum transmission power), and can include any quantity of additional sets of power headroom values and maximum transmission power, up to PHₙ and P_{CMAX,n}, for a total of n sets of values. For the example of a second power headroom value and second maximum transmission power, the MAC CE 203 may thus include four octets, and includes PH₁ (a first power headroom value), P_{CMAX,1} (a first maximum transmission power), PH₂ (a second power headroom value), and P_{CMAX,2} (a second maximum transmission power). MPE may be optionally included, or omitted and two R bits included instead.

FIG. 2D shows an example MAC CE 204, according to one or more aspects described herein. In one or more embodiments, MAC CE 204 supports one or more aspects of methods and apparatus for SRS enhancements, as further described herein. In some embodiments, MAC CE 204 is an example MAC CE where multiple MPEs are reported for different SRS resource/SRS port combinations. In one or more embodiments, MAC CE 204 is an example of a PHR report where the one or more power headroom reports include a first maximum transmission power reduction for the first SRS resource, and a second maximum transmission power reduction for the second SRS resource. MAC CE 204 includes an MPE₁ (a first MPE value) and can include any quantity of additional MPEs, up to MPEₙ, for a total of n MPE values. For the example of a second MPE value, the MAC CE 204 may thus include three octets, and include MPE₁ (a first MPE value), MPE₂ (a second MPE value), and a single PH value and P_{CMAX} value.

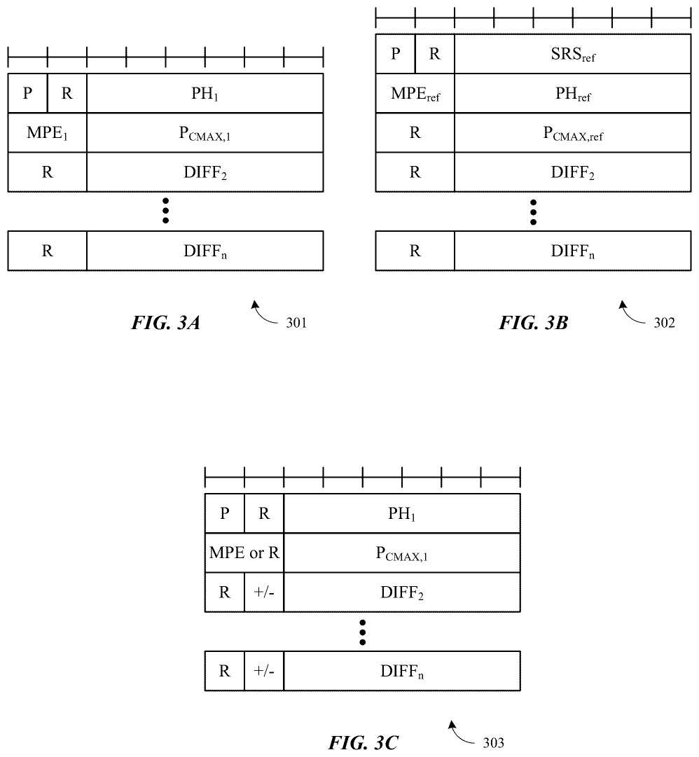

FIG. 3A shows an example MAC CE 301, according to one or more aspects described herein. In one or more embodiments, MAC CE 301 supports one or more aspects of methods and apparatus for SRS enhancements, as further described herein. In some embodiments, one or more power headroom reports include a first power headroom report and a second power headroom report. The first power headroom report indicates the first power value for the first SRS resource, the second power headroom report indicates the second power value for the second SRS resource, and the first power value is independently encoded from the second power value. In some embodiments, MAC CE 301 is an example of where differential encoding and/or quantization is used for multiple PH, P_{CMAX}, and/or MPEs. In one or more embodiments, MAC CE 301 is an example of a PHR report where the one or more power headroom reports comprise a first power headroom report and a second power headroom report, wherein the first power headroom report indicates the first power value for the first SRS resource, the second power headroom report indicates the second power value for the second SRS resource, and the first power value is differentially encoded relative to the second power value. MAC CE 301 includes a PH₁, MPE₁, and P_{CMAX,1} for a first SRS resource/SRS port combination. The MAC CE 301 can include any quantity of additional insertion loss difference values (DIFF), up to DIFFₙ, for a total of n−1 DIFF values. The value of DIFF may be with reference to one or more of PH₁, MPE₁, or P_{CMAX,1} to signal the difference between the insertion loss for another SRS resource/SRS port combination relative to the first SRS resource/SRS port combination. For the example of two SRS resource/SRS port combinations, one DIFF value can be used (e.g., DIFF₂), and the MAC CE 301 may thus include three octets.

In one or more embodiments, MAC CE 301 illustrates an example where a single PH/P_{CMAX}/MPE is reported, and the insertion loss difference of different SRS resource/SRS port combinations are reported with respect to the reference SRS resource/SRS port combination. In some embodiments, two or more of PH, P_{CMAX}, or MPE are reported for a reference SRS resource/SRS port combination, and difference values are reported individually for each of the two or more of PH, P_{CMAX}, or MPE.

FIG. 3B shows an example MAC CE 302, according to one or more aspects described herein. In one or more embodiments, MAC CE 302 supports one or more aspects of methods and apparatus for SRS enhancements, as further described herein. In some embodiments, the PH report can include an indication of a reference SRS resource (SRS_{ref}) for differential encoding. In some embodiments, MAC CE 302 is an example of where differential encoding and/or quantization is used for multiple PH, P_{CMAX}, and/or MPEs with reference to SRS_{ref}. In one or more embodiments, the PH report includes the index of the SRS resource/SRS port (SRS_{ref}) that is used for the reference of differential encoding. The differential values (DIFF) of the other SRS resource/SRS ports are then reported. MAC CE 302 includes a PH_{ref}, MPE_{ref}, and P_{CMAX,ref} for SRS_{ref}. The MAC CE 302 can include any quantity of additional insertion loss difference values (DIFF) for additional SRS resource/SRS ports, up to DIFFₙ, for a total of n−1 DIFF values. The value of DIFF may be with reference to one or more of PH_{ref}, MPE_{ref}, or P_{CMAX}, ref to signal the difference between the insertion loss for another SRS resource/SRS port combination relative to the reference SRS resource/SRS port combination. For the example of two SRS resource/SRS port combinations, one DIFF value can be used (e.g., DIFF₂), and the MAC CE 302 may thus include four octets. In some embodiments, an indication of a sign for the difference may not be needed, for example, because SRS_{ref} can be selected such that the sign is always positive, or always negative.

FIG. 3C shows an example MAC CE 303, according to one or more aspects described herein. In one or more embodiments, MAC CE 303 supports one or more aspects of methods and apparatus for SRS enhancements, as further described herein. In some embodiments, the PH report can include an indication of a sign for the differential encoding, where the reference SRS resource is the first SRS resource and the sign indicates one of an increase or a decrease from the first power value to the second power value. In some embodiments, MAC CE 303 is an example of where differential encoding and/or quantization is used for multiple PH, P_{CMAX}, and/or MPEs with reference to the first SRS resource/SRS port. In one or more embodiments, the PH report includes an indication of the sign (e.g., plus or minus) for differential values (DIFF) of the other SRS resource/SRS ports, as well as the DIFF values themselves. MAC CE 303 includes a PH₁, MPE₁, and P_{CMAX,1} for the first SRS resource/SRS port. The MAC CE 303 can include any quantity of additional insertion loss difference values (DIFF) for additional SRS resource/SRS ports, up to DIFFₙ, for a total of n−1 DIFF values. The value of DIFF may be with reference to one or more of PH₁, MPE₁, and P_{CMAX,1} to signal the difference between the insertion loss for another SRS resource/SRS port combination relative to the first SRS resource/SRS port. For the example of two SRS resource/SRS port combinations, one DIFF value can be used (e.g., DIFF₂), and the MAC CE 303 may thus include three octets. In some embodiments, an indication of a sign for the difference may be needed because the insertion loss difference between the second and the first SRS resource/SRS port may be positive in some cases, and negative in other cases.

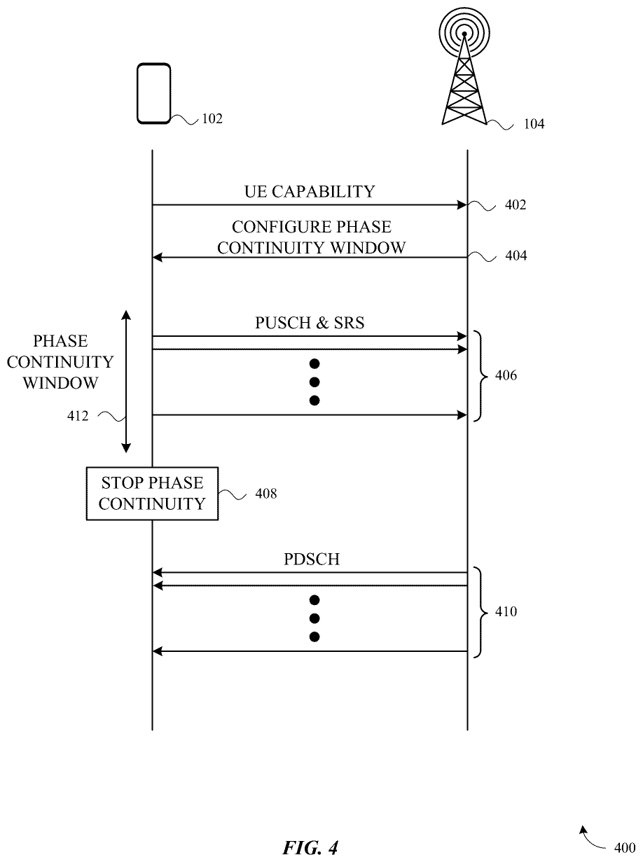

FIG. 4 shows an example signaling diagram 400, according to one or more aspects described herein. In one or more embodiments, signaling diagram 400 supports one or more aspects of methods and apparatus for SRS enhancements, as further described herein.

At 402, UE 102 can provide UE capability signaling to the network device 104. In one or more embodiments, the UE capability signaling is control signaling (e.g., RRC signaling) indicating a capability of the UE 102 to maintain a same phase for SRS transmissions for a phase continuity window. In some embodiments, the UE 102 can also report the maximum duration of the time domain window that UE 102 can maintain phase continuity for SRS transmission. In some embodiments the indicated capability is associated with one of a codebook usage, a non-codebook usage, or an antenna switching usage. The UE 102 can then report a different UE capability for the phase continuity window for different usages.

At 404, the network device 104 transmits to the UE 102 control signaling identifying a phase continuity window 412 for the UE 102. In some embodiments, the phase continuity window 412 is a time duration during which the UE 102 is to maintain a same precoder, a same phase, or both, for SRS transmissions. In some embodiments, the phase continuity window is applicable to periodic SRS transmissions. In some embodiments, the phase continuity window is applicable to semi-persistently scheduled SRS transmissions. In one or more embodiments, the phase continuity window 412 can be specified as a quantity of slots, symbols, or other time duration. The reference for the start of the phase continuity window 412 can be the first configured SRS transmission after subframe number (SFN) 0. In some embodiments the phase continuity window configuration may be associated with one of a codebook usage, a non-codebook usage, or an antenna switching usage. The network device 104 can then provide to (configure) the UE 102 with a different phase continuity window for different usages.

At 406, the UE 102 transmits a set of PUSCH and SRS signals 406 to network device 104. During the phase continuity window 412, the UE 102 maintains a consistent phase. In one or more embodiments, during the phase continuity window 412, the UE 102 additionally maintains a same SRS transmission power. In some embodiments, the same SRS transmission power is maintained for one or both of periodic SRS transmissions, semi-persistently scheduled SRS transmissions, or both.

In one or more embodiments, during the phase continuity window 412, the UE 102 maintains a same spatial relation (e.g., analog beam, quasi-co-location relation). In some embodiments, the UE 102 maintains the same spatial relation when the usage applicable to the SRS being transmitted is for beam management (e.g., “beamManagement” usage).

In some embodiments, the UE 102 is not expected to maintain the phase continuity window 412 when there is a duplexing direction change for a TDD spectrum. That is, if the UE 102 is to switch from transmitting a set of PUSCH and SRS signals 406 to the network device 104 to receiving a set of physical downlink shared channel (PDSCH) signals 410 from the network device 104, then the UE 102 stops maintaining phase continuity at 408 prior to the PDSCH signals.

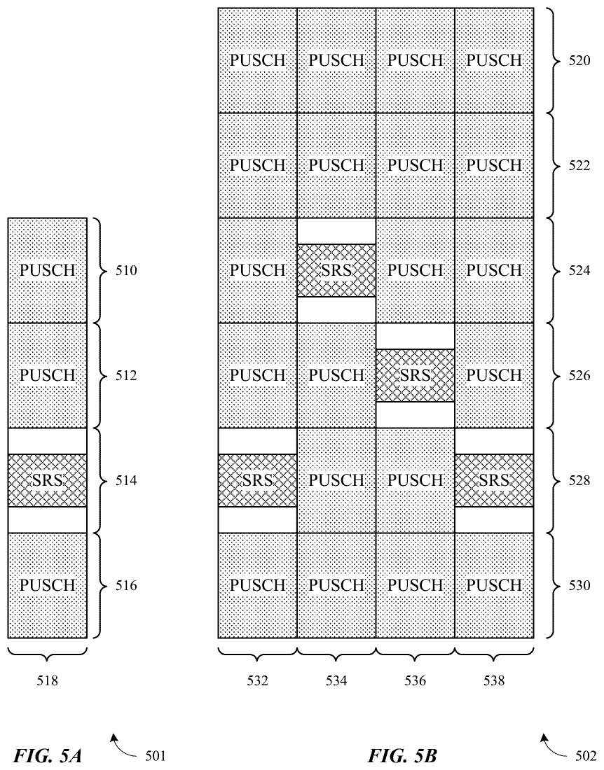

FIG. 5A shows an example resource allocation 501, according to one or more aspects described herein. In one or more embodiments, resource allocation 501 supports one or more aspects of methods and apparatus for SRS enhancements, as further described herein.

To allocate frequency resources on an uplink shared channel (e.g., PUSCH), frequency domain resource allocation (FDRA) signaling can be used. In some cases (e.g., for non-interlaced PUSCH), two types of FDRA may be supported. A first type of FDRA is uplink resource allocation type 0, which is a bitmap that is used for FDRA, where each bit of the bitmap represents one correct resource (e.g., one resource block group (RBG)). A second type of FDRA is uplink resource allocation type 1, where contiguous physical resource blocks (PRBs) are allocated by identifying the starting PRB, and a quantity of PRBs of the allocation from the starting PRB.

In one or more embodiments, DFT-s-OFDM may be used for an uplink shared channel, for example when a transform precoder is enabled for UE 102, the network (e.g., via network device 104) can configure the UE 102 to use uplink resource allocation type 0 for FDRA (the bitmap for FDRA). In one or more embodiments, resource allocation 501 illustrates four RBGs in a time duration 518 (e.g., a symbol, set of symbols, slot), including a first RBG 510, second RBG 512, third RBG 514, and fourth RBG 516. A FDRA bitmap in a DCI message may be used to allocate RBGs for PUSCH for resource allocation 501 even though SRS signals are allocated to a third RBG 514. The SRS signals may then be rate matched around the PUSCH to RBGs according to the FDRA bitmap.

In some embodiments, the number of non-contiguous segments of the FDRA allocation may be restricted. In one or more embodiments, the maximum number of non-contiguous segments of FDRA can be fixed (e.g., hardcoded). In other embodiments, the maximum number of non-contiguous segments of FDRA can be reported by a UE 102 as UE capability signaling.

In one or more embodiments, for example where DFT-s-OFDM is used for PUSCH (transform precoder is enabled) and a type 0 resource allocation is used for FDRA, an increased size of RBG can be used. For example, the nominal RBG size corresponding to different bandwidth part (BWP) sizes may be configured as provided in Table 1:

TABLE 1
Nominal RBG Size

| BWP Size | Configuration 1 | Configuration 2 |
|---|---|---|
| 1-36 | 8 | 16 |
| 37-72 | 16 | 16 |
| 73-144 | 32 | 32 |
| 145-275 | 32 | 64 |

FIG. 5B shows an example resource allocation 502, according to one or more aspects described herein. In one or more embodiments, resource allocation 502 supports one or more aspects of methods and apparatus for SRS enhancements, as further described herein. Resource allocation 502 includes aspects described with reference to resource allocation 501, with further details described for clarity.

In some embodiments, a PUSCH can span multiple symbols, for example a first symbol 532, a second symbol 534, a third symbol 536, and a fourth symbol 538. A different FDRA may be configured for each of the different symbol periods. Each symbol may have a different FDRA applicable to the set of RBGs (e.g., a first RBG 520, a second RBG 522, a third RBG 524, a fourth RBG 526, a fifth RBG 528, and a sixth RBG 530). For example, as illustrated for resource allocation 502 having four symbols, each symbol may have a different FDRA resulting in four FDRAs. The SRS signals may then be rate matched around the PUSCH to RBGs according to the four FDRA bitmaps.

Alternatively, in some embodiments, PUSCH symbols may be divided into multiple subsets of consecutive symbols, where a symbol in each subset may have the same FDRA, and symbols in different subsets can be configured with a different FDRA. For a PUSCH with multiple symbols, the same uplink resource allocation type (e.g., type 0 or type 1) can be used across all the multiple symbols.

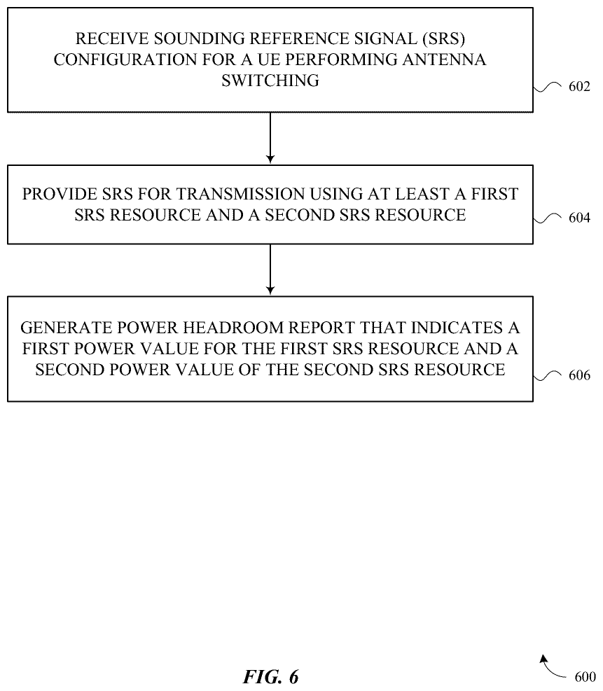

FIG. 6 shows an example method 600 of wireless communication by a UE or baseband processor. In one or more embodiments, method 600 supports one or more aspects of methods and apparatus for SRS enhancements, as further described herein. In some cases, the UE may be the UE 102, wireless device 1302, or one of the other UEs described herein. The method 600 may be performed using a processor (e.g., a baseband processor), a transceiver (or a main radio), or other components of the UE.

At 602, the method 600 includes receiving control signaling that indicates an SRS configuration of a plurality of SRS ports associated with a plurality of antenna ports of a UE configured for performing antenna switching using the plurality of antenna ports, the SRS configuration identifying at least a first SRS resource and a second SRS resource.

At 604, the method 600 includes providing SRSs for transmission via the plurality of antenna ports using at least the first SRS resource and the second SRS resource. In some embodiments, a UE performs transmitting the SRSs using a plurality of antenna ports of the UE using at least the first SRS resource and the second SRS resource.

At 606, the method 600 includes generating a control message for transmission that includes one or more power headroom reports that indicate a first power value for the first SRS resource and a second power value of the second SRS resource. In some embodiments, a UE performs transmitting a control message that includes one or more power headroom reports that indicate a first power value for the first SRS resource and a second power value for the second SRS resource.

In some embodiments, a difference between the first power value and the second power value indicates an insertion loss difference between different antenna ports of the plurality of antenna ports. In some embodiments, the first power value for the first SRS resource or the second power value for the second SRS resource are for two or more antenna ports of the plurality of antenna ports. In some embodiments, the control message includes a MAC CE that includes a first power headroom report that indicates the first power value for the first SRS resource and a second power headroom report that indicates the second power value for the second SRS resource.

In some embodiments, the one or more power headroom reports include a power headroom report that indicates a first maximum transmission power for the first SRS resource, a second maximum transmission power for the second SRS resource, and a single power headroom value for both the first SRS resource and the second SRS resource. In some embodiments, the one or more power headroom reports include a power headroom report that indicates a first power headroom value for the first SRS resource, a second power headroom value for the second SRS resource, and a single maximum transmission power for both the first SRS resource and the second SRS resource. In some embodiments, the one or more power headroom reports include a power headroom report that indicates a first power headroom value and a first maximum transmission power for the first SRS resource, and indicates a second power headroom value and a second maximum transmission power for the second SRS resource. In some embodiments, the one or more power headroom reports include a first maximum transmission power reduction for the first SRS resource, and a second maximum transmission power reduction for the second SRS resource. In some embodiments, the one or more power headroom reports include a power headroom report that indicates a single maximum transmission power reduction for both the first SRS resource and the second SRS resource. In some embodiments, the one or more power headroom reports include a first power headroom report and a second power headroom report, where the first power headroom report indicates the first power value for the first SRS resource, the second power headroom report indicates the second power value for the second SRS resource, and the first power value is independently encoded from the second power value.

In some embodiments, the one or more power headroom reports include a first power headroom report and a second power headroom report, where the first power headroom report indicates the first power value for the first SRS resource, the second power headroom report indicates the second power value for the second SRS resource, and the first power value is differentially encoded relative to the second power value. In some embodiments, the method further includes transmitting, in the one or more power headroom reports, an indication of a reference SRS resource for the differential encoding, where the reference SRS resource is one of the first SRS resource or the second SRS resource. In some embodiments, the method further includes transmitting, in the one or more power headroom reports, an indication of a sign for the differential encoding, where the reference SRS resource is the first SRS resource, and the sign indicates one of an increase or a decrease from the first power value to the second power value.

In some embodiments, the one or more power headroom reports are transmitted in a UE assistance information message via radio resource control signaling. In some embodiments, the one or more power headroom reports are generated (e.g., by the baseband processor) for transmission in a UE assistance information message via radio resource control signaling.

In one or more embodiments, the method further includes transmitting, to a network entity, control signaling indicating a capability of the UE to maintain a same phase for SRS transmissions for a phase continuity window. In some embodiments, control signaling is generated (e.g., by the baseband processor) for transmission to the network device, the control signaling indicating a capability of the UE to maintain a same phase for SRS transmissions for a phase continuity window. In some embodiments, the indicated capability is associated with one of a codebook usage, a non-codebook usage, or an antenna switching usage.

In one or more embodiments, the method further includes receiving, from a network entity, control signaling identifying a phase continuity window during which the UE is to maintain a same precoder and a same phase for SRS transmissions, the phase continuity window applicable to periodic or semi-persistent SRS transmissions.

In some embodiments, the phase continuity window is a first phase continuity window associated with one of a codebook usage, a non-codebook usage, or an antenna switching usage, and the method further includes receiving control signaling identifying a second phase continuity window associated with a different one of the codebook usage, the non-codebook usage, or the antenna switching usage. In some embodiments, a switch between an uplink data transmission and a downlink data reception within the phase continuity window releases the UE from maintaining the same phase for SRS transmissions. In some embodiments, the UE is not expected to maintain, within the phase continuity window, phase continuity following a switch between an uplink transmission and a downlink reception. In one or more embodiments, the method further includes maintaining a same SRS transmission power within the phase continuity window. In one or more embodiments, the method further includes maintaining a same spatial relation within the phase continuity window.

In one or more embodiments, the method further includes receiving control signaling that indicates the use of DFT-s-OFDM for an uplink shared channel in a radio frequency spectrum band; and receiving DCI signaling that includes a bitmap allocating frequency resources of the radio frequency spectrum band for the uplink shared channel.

In one or more embodiments, the method further includes receiving control signaling that indicates the use of DFT-s-OFDM for an uplink shared channel in a radio frequency spectrum band; and receiving DCI signaling that includes at least a first bitmap allocating a first set of frequency resources of the radio frequency spectrum band for the uplink shared channel in a first one or more symbols of a slot, and a second bitmap allocating a second set of frequency resources of the radio frequency spectrum band for the uplink shared channel in a second one or more symbols of the slot.

The method 600 may be variously embodied, extended, or adapted, as described in the following paragraphs and elsewhere in this description.

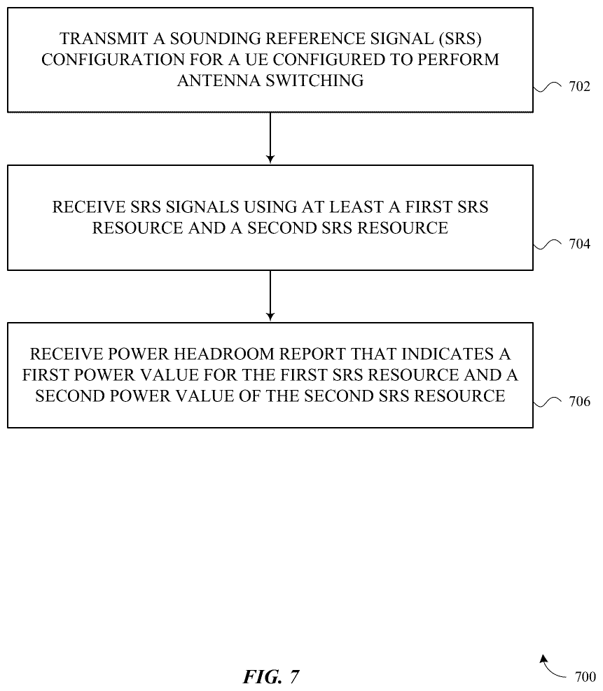

FIG. 7 shows an example method 700 of wireless communication by a network device. In one or more embodiments, method 700 supports one or more aspects of methods and apparatus for SRS enhancements, as further described herein. In some cases, the network device may be the network device 104, network device 1320, or one of the other network devices described herein. The method 700 may be performed using a processor (e.g., a baseband processor), a transceiver (e.g., main radio), or other components of the network device.

At 702, the method 700 includes transmitting, to a UE, control signaling that indicates an SRS configuration of a plurality of SRS ports associated with a plurality of antenna ports of the UE, the UE configured to perform antenna switching using the plurality of antenna ports, and the SRS configuration identifying at least a first SRS resource and a second SRS resource.

At 704, the method 700 includes receiving SRS signals using at least the first SRS resource and the second SRS resource.

At 706, the method 700 includes receiving, from the UE, a control message that includes one or more power headroom reports that indicate a first power value for the first SRS resource and a second power value for the second SRS resource.

In some embodiments, a difference between the first power value and the second power value indicates an insertion loss difference between antenna ports of the plurality of antenna ports. In some embodiments, the first power value for the first SRS resource or the second power value for the second SRS resource are for two or more antenna ports of the plurality of antenna ports. In some embodiments, the control message includes a MAC CE that includes a first power headroom report that indicates the first power value for the first SRS resource and a second power headroom report that indicates the second power value for the second SRS resource.

In some embodiments, the one or more power headroom reports include a power headroom report that indicates a first maximum transmission power for the first SRS resource, a second maximum transmission power for the second SRS resource, and a single power headroom value for both the first SRS resource and the second SRS resource. In some embodiments, the one or more power headroom reports include a power headroom report that indicates a first power headroom value for the first SRS resource, a second power headroom value for the second SRS resource, and a single maximum transmission power for both the first SRS resource and the second SRS resource. In some embodiments, the one or more power headroom reports include a power headroom report that indicates a first power headroom value and a first maximum transmission power for the first SRS resource, and indicates a second power headroom value and a second maximum transmission power for the second SRS resource. In some embodiments, the one or more power headroom reports include a first maximum transmission power reduction for the first SRS resource, and a second maximum transmission power reduction for the second SRS resource. In some embodiments, the one or more power headroom reports include a power headroom report that indicates a single maximum transmission power reduction for both the first SRS resource and the second SRS resource. In some embodiments, the one or more power headroom reports include a first power headroom report and a second power headroom report, where the first power headroom report indicates the first power value for the first SRS resource, the second power headroom report indicates the second power value for the second SRS resource, and the first power value is independently encoded from the second power value.

In some embodiments, the one or more power headroom reports include a first power headroom report and a second power headroom report, where the first power headroom report indicates the first power value for the first SRS resource, the second power headroom report indicates the second power value for the second SRS resource, and the first power value is differentially encoded relative to the second power value. In some embodiments, the method further includes receiving, in the one or more power headroom reports, an indication of a reference SRS resource for the differential encoding, where the reference SRS resource is one of the first SRS resource or the second SRS resource. In some embodiments, the method further includes receiving, in the one or more power headroom reports, an indication of a sign for the differential encoding, where the reference SRS resource is the first SRS resource, and the sign indicates one of an increase or a decrease from the first power value to the second power value.

In some embodiments, the one or more power headroom reports are transmitted in a UE assistance information message via radio resource control signaling.

In one or more embodiments, the method further includes receiving, from the UE, control signaling indicating a capability of the UE to maintain a same phase for SRS transmissions for a phase continuity window. In some embodiments, the indicated capability is associated with one of a codebook usage, a non-codebook usage, or an antenna switching usage.

In one or more embodiments, the method further includes transmitting, to the UE, control signaling identifying a phase continuity window during which the UE is to maintain a same precoder and a same phase for SRS transmissions, the phase continuity window applicable to periodic or semi-persistent SRS transmissions. In some embodiments, the phase continuity window is a first phase continuity window associated with one of a codebook usage, a non-codebook usage, or an antenna switching usage, and the at least one processor core is further configured to cause the method to receive control signaling identifying a second phase continuity window associated with a different one of the codebook usage, the non-codebook usage, or the antenna switching usage. In some embodiments, a switch between an uplink data transmission and a downlink data reception within the phase continuity window releases the UE from maintaining the same phase for SRS transmissions. In some embodiments, the UE is not expected to maintain, within the phase continuity window, phase continuity following a switch between an uplink transmission and a downlink reception. In some embodiments, the UE is to maintain a same SRS transmission power within the phase continuity window. In some embodiments, the UE is to maintain a same spatial relation within the phase continuity window.

In one or more embodiments, the method further includes transmitting, to the UE, control signaling that indicates the use of DFT-s-OFDM for an uplink shared channel in a radio frequency spectrum band; and transmitting, to the UE, DCI signaling that includes a bitmap allocating frequency resources of the radio frequency spectrum band for the uplink shared channel.

In one or more embodiments, the method further includes transmitting, to the UE, control signaling that indicates the use of DFT-s-OFDM for an uplink shared channel in a radio frequency spectrum band; and transmitting, to the UE, DCI signaling that includes at least a first bitmap allocating a first set of frequency resources of the radio frequency spectrum band for the uplink shared channel in a first one or more symbols of a slot, and a second bitmap allocating a second set of frequency resources of the radio frequency spectrum band for the uplink shared channel in a second one or more symbols of the slot.

The method 700 may be variously embodied, extended, or adapted, as described in the following paragraphs and elsewhere in this description.

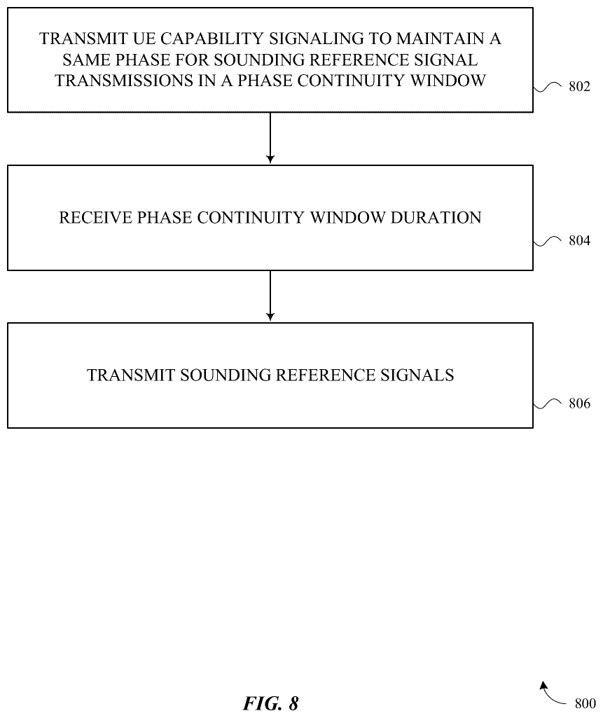

FIG. 8 shows an example method 800 of wireless communication by a UE or baseband processor. In one or more embodiments, method 800 supports one or more aspects of methods and apparatus for sounding reference signal enhancements, as further described herein. In some cases, the UE may be the UE 102, wireless device 1302, or one of the other UEs described herein. The method 800 may be performed using a processor (e.g., a baseband processor), a transceiver (or a main radio), or other components of the UE.

At 802, the method 800 includes transmitting, to a network entity, control signaling indicating a capability of the UE to maintain a same phase for SRS transmissions for a time duration of a phase continuity window. In some embodiments, a baseband processor performs generating control signaling for transmission to a network entity, the control signaling indicating a capability of a UE to maintain a same phase for SRS transmissions for a time duration of a phase continuity window.

At 804, the method 800 includes receiving, from the network entity and at least in part in response to the transmitted control signaling, an indication of the time duration of the phase continuity window during which the UE is to maintain the same phase for SRSs.

At 806, the method 800 includes transmitting SRSs according to the phase continuity window. In some embodiments, a baseband processor performs providing SRSs to be transmitted according to the phase continuity window.

In some embodiments, the phase continuity window is applicable to periodic SRS transmissions. In some embodiments, the indicated capability is associated with one of a codebook usage, a non-codebook usage, or an antenna switching usage. In one or more embodiments, the method further includes receiving, from a network entity, control signaling identifying a phase continuity window during which the UE is to maintain a same precoder for SRS transmissions. In some embodiments, the phase continuity window is a first phase continuity window associated with one of a codebook usage, a non-codebook usage, or an antenna switching usage, and the method further includes receiving control signaling identifying a second phase continuity window associated with a different one of the codebook usage, the non-codebook usage, or the antenna switching usage. In some embodiments, a switch between an uplink data transmission and a downlink data reception within the phase continuity window releases the UE from maintaining the same phase for SRS transmissions. In some embodiments, the UE is not expected to maintain, within the phase continuity window, phase continuity following a switch between an uplink transmission and a downlink reception. In one or more embodiments, the method further includes maintaining a same SRS transmission power within the phase continuity window. In one or more embodiments, the method further includes maintaining a same spatial relation within the phase continuity window.

The method 800 may be variously embodied, extended, or adapted, as described in the following paragraphs and elsewhere in this description.

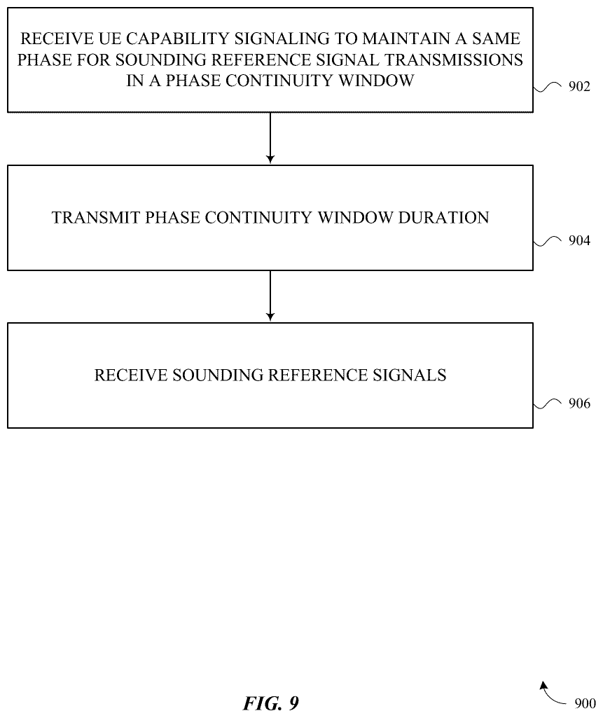

FIG. 9 shows an example method 900 of wireless communication by a network device. In one or more embodiments, method 900 supports one or more aspects of method and apparatus for sounding reference signal enhancements, as further described herein. In some cases, the network device may be the network device 104, network device 1320, or one of the other network devices described herein. The method 900 may be performed using a processor, a transceiver (e.g., main radio), or other components of the network device.

At 902, the method 900 includes receiving, from a UE, control signaling indicating a capability of the UE to maintain a same phase for SRS transmissions for a time duration of a phase continuity window.

At 904, the method 900 includes transmitting, to the UE and at least in part in response to the received control signaling, an indication of the time duration of the phase continuity window during which the UE is to maintain the same phase for SRS signals.

At 906, the method 900 includes receiving SRS signals according to the phase continuity window.

In some embodiments, the phase continuity window is applicable to periodic SRS transmissions. In some embodiments, the phase continuity window is applicable to semi-persistent SRS transmissions. In some embodiments, the indicated capability is associated with one of a codebook usage, a non-codebook usage, or an antenna switching usage. In one or more embodiments, the method further includes transmitting, to the UE, control signaling identifying a phase continuity window during which the UE is to maintain a same precoder for SRS transmissions. In some embodiments, the phase continuity window is a first phase continuity window associated with one of a codebook usage, a non-codebook usage, or an antenna switching usage, and the method further includes transmitting, to the UE, control signaling identifying a second phase continuity window associated with a different one of the codebook usage, the non-codebook usage, or the antenna switching usage. In some embodiments, a switch between an uplink data transmission and a downlink data reception within the phase continuity window releases the UE from maintaining the same phase for SRS transmissions. In some embodiments, the UE is not expected to maintain, within the phase continuity window, phase continuity following a switch between an uplink transmission and a downlink reception. In some embodiments, the UE is expected to maintain a same SRS transmission power within the phase continuity window. In one or more embodiments, the method further includes the UE is expected to maintain a same spatial relation within the phase continuity window.

The method 900 may be variously embodied, extended, or adapted, as described in the following paragraphs and elsewhere in this description.

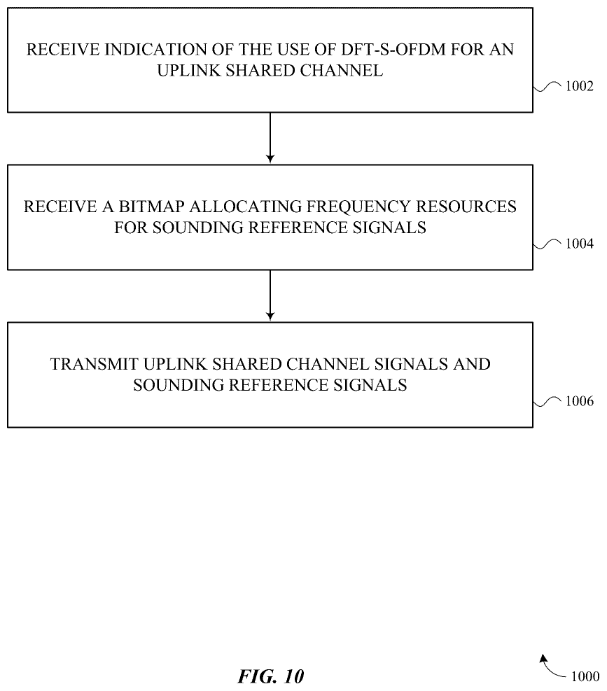

FIG. 10 shows an example method 1000 of wireless communication by a UE or a baseband processor. In one or more embodiments, method 1000 supports one or more aspects of methods and apparatus for sounding reference signal enhancements, as further described herein. In some cases, the UE may be the UE 102, wireless device 1302, or one of the other UEs described herein. The method 1000 may be performed using a processor (e.g., a baseband processor), a transceiver (or a main radio), or other components of the UE.

At 1002, the method 1000 includes receiving, from a network entity, control signaling that indicates the use of DFT-s-OFDM for an uplink shared channel in a radio frequency spectrum band, the radio frequency spectrum band including a plurality of frequency resources.

At 1004, the method 1000 includes receiving, from a network entity, DCI signaling that includes a bitmap allocating one or more frequency resources of the plurality of frequency resources of the radio frequency spectrum band for the uplink shared channel, one or more remaining frequency resources of the plurality of frequency resources for SRS signals.

At 1006, the method 1000 includes transmitting, to the network entity, uplink shared channel signals and SRS signals on the plurality of frequency resources according to the transmitted DCI signaling. In some embodiments, a baseband processor performs generating uplink shared channel signals and SRS signals for transmission to the network entity on the plurality of frequency resources according to the transmitted DCI signaling.

In some embodiments, the bitmap includes a first bitmap, and the DCI signaling further includes at least a second bitmap allocating a second set of frequency resources of the radio frequency spectrum band for the uplink shared channel in a second one or more symbols of the slot.

The method 1000 may be variously embodied, extended, or adapted, as described in the following paragraphs and elsewhere in this description.

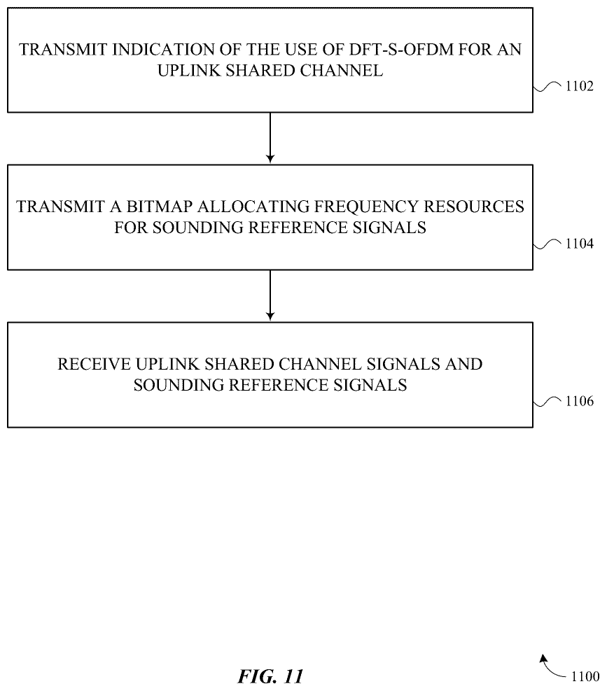

FIG. 11 shows an example method 1100 of wireless communication by a network device. In one or more embodiments, method 1100 supports one or more aspects of method and apparatus for sounding reference signal enhancements, as further described herein. In some cases, the network device may be the network device 104, network device 1320, or one of the other network devices described herein. The method 1100 may be performed using a processor (e.g., a baseband processor), a transceiver (e.g., main radio), or other components of the network device.

At 1102, the method 1100 includes transmitting, to a UE, control signaling that indicates the use of DFT-s-OFDM for an uplink shared channel in a radio frequency spectrum band, the radio frequency spectrum band including a plurality of frequency resources.

At 1104, the method 1100 includes transmitting, to the UE, DCI signaling that includes a bitmap allocating one or more frequency resources of the plurality of frequency resources of the radio frequency spectrum band for the uplink shared channel, one or more remaining frequency resources of the plurality of frequency resources for SRS signals.

At 1106, the method 1100 includes receiving, from the UE, uplink shared channel signals and SRS signals on the plurality of frequency resources according to the transmitted DCI signaling.

In some embodiments, the bitmap includes a first bitmap, and the DCI signaling further includes at least a second bitmap allocating a second set of frequency resources of the radio frequency spectrum band for the uplink shared channel in a second one or more symbols of the slot.

The method 1100 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 600, 700, 800, 900, 1000, or 1100. In the context of method 600, 800, or 1000, this non-transitory computer-readable media may be, for example, a memory of a UE (such as a memory 1306 of a wireless device 1302 that is a UE, as described herein). In the context of method 700, 900, or 1100, this non-transitory computer-readable media may be, for example, a memory of a network device (such as a memory 1324 of a network device 1320, as described herein).

Embodiments contemplated herein include an apparatus having logic, modules, or circuitry to perform one or more elements of the method 600, 700, 800, 900, 1000, or 1100. In the context of method 600, 800, or 1000, this apparatus may be, for example, an apparatus of a UE (such as a wireless device 1302 that is a UE). In the context of method 700, 900, or 1100, this apparatus may be, for example, an apparatus of a network device (such as a network device 1320, as described herein).

Embodiments contemplated herein include an apparatus having one or more processors and one or more computer-readable media, using or storing instructions that, when executed by the one or more processors, cause the one or more processors to perform one or more elements of the method 600, 700, 800, 900, 1000, or 1100. In the context of method 600, 800, or 1000, this apparatus may be, for example, an apparatus of a UE (such as a wireless device 1302 that is a UE, as described herein). In the context of the method 700, 900, or 1100, this apparatus may be, for example, an apparatus of a network device (such as a network device 1320, as described herein).

Embodiments contemplated herein include a signal as described in or related to one or more elements of the method 600, 700, 800, 900, 1000, or 1100.

Embodiments contemplated herein include a computer program or computer program product having instructions, wherein execution of the program by a processor causes the processor to carry out one or more elements of the method 600, 700, 800, 900, 1000, or 1100. In the context of method 600, 800, or 1000, the processor may be a processor of a UE (such as a processor(s) 1304 of a wireless device 1302 that is a UE, as described herein), and the instructions may be, for example, located in the processor and/or on a memory of the UE (such as a memory 1306 of a wireless device 1302 that is a UE, as described herein). In the context of method 700, 900, or 1100, the processor may be a processor of a network device (such as a processor(s) 1322 of a network device 1320, as described herein), and the instructions may be, for example, located in the processor and/or on a memory of the network device (such as a memory 1324 of a network device 1320, as described herein).

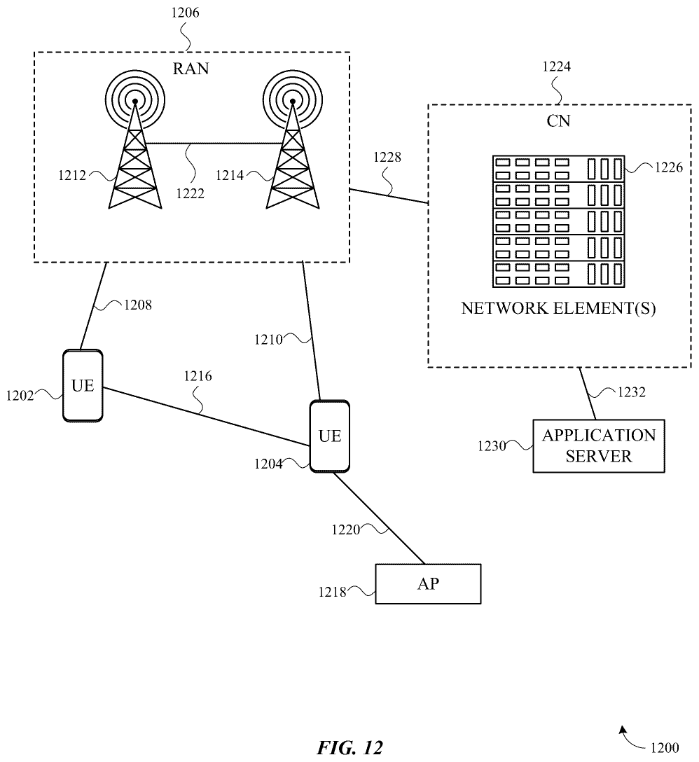

FIG. 12 illustrates an example architecture of a wireless communication system, according to embodiments described herein. The following description is provided for an example wireless communication system 1200 that operates in conjunction with the LTE system standards or specifications and/or 5G or NR system standards or specifications, as provided by 3GPP technical specifications.

As shown, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks) but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more network devices, such as base station 1212 and base station 1214, that enable the connection 1208 and connection 1210.

In this example, the connection 1208 and connection 1210 are air interfaces to enable such communicative coupling and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In some embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more network devices of a RAN (e.g., two or more eNBs and the like) that connect to an EPC, and/or between two eNBs connected to the EPC. In embodiments where the wireless communication system 1200 is an NR system (e.g., when CN 1224 is a 5GC), the interface 1222 may be an Xn interface. The Xn interface is defined between two or more network devices of a RAN (e.g., two or more gNBs and the like) that connect to the 5GC, between a base station 1212 (e.g., a gNB) connecting to the 5GC and an eNB, and/or between two eNBs connecting to the 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In some embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In some embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

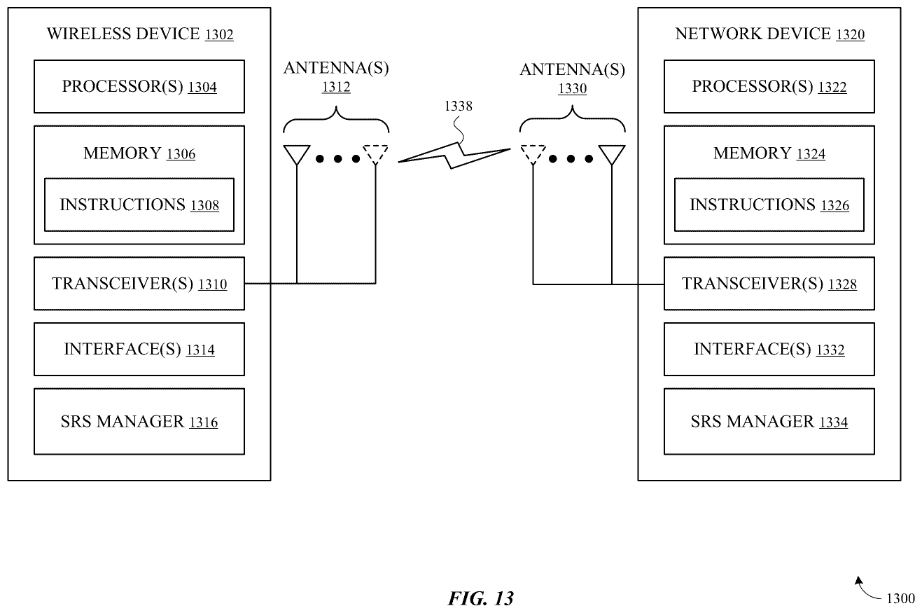

FIG. 13 illustrates an example system 1300 for performing signaling 1338 between a wireless device 1302 and a network device 1320, according to embodiments described herein. The system 1300 may be a portion of a wireless communication system as herein described. The wireless device 1302 may be, for example, a UE of a wireless communication system. The network device 1320 may be, for example, a base station (e.g., an eNB or a gNB) or a radio head of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 (also collectively referred to as a transceiver 1310) that may include radio frequency (RF) transmitter and/or receiver circuitry that use the antenna(s) 1312 of the wireless device 1302 to facilitate signaling (e.g., the signaling 1338) to and/or from the wireless device 1302 with other devices (e.g., the network device 1320) according to corresponding RATs.

The wireless device 1302 may include one or more antenna(s) 1312 (e.g., one, two, four, eight, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In some embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include SRS manager 1316. The SRS manager 1316 may be implemented via hardware, software, or combinations thereof. For example, the SRS manager 1316 may be implemented as a processor, circuit, and/or instructions 1308 stored in the memory 1306 and executed by the processor(s) 1304. In some examples, the SRS manager 1316 may be integrated within the processor(s) 1304 and/or the transceiver(s) 1310. For example, the SRS manager 1316 may be implemented by a combination of software components (e.g., executed by a DSP or a general processor) and hardware components (e.g., logic gates and circuitry) within the processor(s) 1304 or the transceiver(s) 1310.

The SRS manager 1316 may be used for various aspects of the present disclosure, for example, aspects of FIGS. 1-13, from a wireless device or UE perspective. The SRS manager 1316 may be configured to, for example, perform receiving control signaling that indicates an SRS configuration of a plurality of SRS ports associated with a plurality of antenna ports of a UE configured for performing antenna switching using the plurality of antenna ports, and the SRS configuration identifying at least a first SRS resource and a second SRS resource; providing SRSs for transmission via the plurality of antenna ports using at least the first SRS resource and the second SRS resource; transmitting a control message that includes one or more power headroom reports that indicate a first power value for the first SRS resource and a second power value for the second SRS resource.

The SRS manager 1316 may be configured to, for example, perform transmitting, to a network entity, control signaling indicating a capability of the UE to maintain a same phase for SRS transmissions for a time duration of a phase continuity window; receiving, from the network entity and at least in part in response to the transmitted control signaling, an indication of the time duration of the phase continuity window during which the UE is to maintain the same phase for SRSs; and transmitting SRSs according to the phase continuity window.

The SRS manager 1316 may be configured to, for example, perform receiving, from a network entity, control signaling that indicates the use of DFT-s-OFDM for an uplink shared channel in a radio frequency spectrum band, the radio frequency spectrum band including a plurality of frequency resources; receiving, from a network entity, DCI signaling that includes a bitmap allocating one or more frequency resources of the plurality of frequency resources of the radio frequency spectrum band for the uplink shared channel, one or more remaining frequency resources of the plurality of frequency resources for SRS signals; and transmitting, to the network entity, uplink shared channel signals and SRSs on the plurality of frequency resources according to the transmitted DCI signaling.

The network device 1320 may include one or more processor(s) 1322. The processor(s) 1322 may execute instructions such that various operations of the network device 1320 are performed, as described herein. The processor(s) 1322 may include one or more baseband processors implemented using, for example, a CPU, a DSP, an ASIC, a controller, an FPGA device, another hardware device, a firmware device, or any combination thereof configured to perform the operations described herein.

The network device 1320 may include a memory 1324. The memory 1324 may be a non-transitory computer-readable storage medium that stores instructions 1326 (which may include, for example, the instructions being executed by the processor(s) 1322). The instructions 1326 may also be referred to as program code or a computer program. The memory 1324 may also store data used by, and results computed by, the processor(s) 1322.

The network device 1320 may include one or more transceiver(s) 1328 (also collectively referred to as a transceiver 1328) that may include RF transmitter and/or receiver circuitry that use the antenna(s) 1330 of the network device 1320 to facilitate signaling (e.g., the signaling 1338) to and/or from the network device 1320 with other devices (e.g., the wireless device 1302) according to corresponding RATs.

The network device 1320 may include one or more antenna(s) 1330 (e.g., one, two, four, or more). In embodiments having multiple antenna(s) 1330, the network device 1320 may perform MIMO, digital beamforming, analog beamforming, beam steering, etc., as has been described.

The network device 1320 may include one or more interface(s) 1332. The interface(s) 1332 may be used to provide input to or output from the network device 1320. For example, a network device 1320 of a RAN (e.g., a base station, a radio head, etc.) may include interface(s) 1332 made up of transmitters, receivers, and other circuitry (e.g., other than the transceiver(s) 1328/antenna(s) 1330 already described) that enables the network device 1320 to communicate with other equipment in a network, and/or that enables the network device 1320 to communicate with external networks, computers, databases, and the like for purposes of operations, administration, and maintenance of the network device 1320 or other equipment operably connected thereto.

The network device 1320 may include at least one SRS manager 1334. The SRS manager 1334 may be implemented via hardware, software, or combinations thereof. For example, the SRS manager 1334 may be implemented as a processor, circuit, and/or instructions 1326 stored in the memory 1324 and executed by the processor(s) 1322. In some examples, the SRS manager 1334 may be integrated within the processor(s) 1322 and/or the transceiver(s) 1328. For example, the SRS manager 1334 may be implemented by a combination of software components (e.g., executed by a DSP or a general processor) and hardware components (e.g., logic gates and circuitry) within the processor(s) 1322 or the transceiver(s) 1328.

The SRS manager 1334 may be used for various aspects of the present disclosure, for example, aspects of FIGS. 1-13, from a network device perspective. The SRS manager 1334 may be configured to, for example, perform transmitting, to a UE, control signaling that indicates an SRS configuration of a plurality of SRS ports associated with a plurality of antenna ports of the UE, the UE configured to perform antenna switching using the plurality of antenna ports, and the SRS configuration identifying at least a first SRS resource and a second SRS resource; receiving SRSs using at least the first SRS resource and the second SRS resource; receiving, from the UE, a control message that includes one or more power headroom reports that indicate a first power value for the first SRS resource and a second power value for the second SRS resource.

The SRS manager 1334 may be configured to, for example, perform receiving, from a UE, control signaling indicating a capability of the UE to maintain a same phase for SRS transmissions for a time duration of a phase continuity window; transmitting, to the UE and at least in part in response to the received control signaling, an indication of the time duration of the phase continuity window during which the UE is to maintain the same phase for SRSs; and receiving SRSs according to the phase continuity window.

The SRS manager 1334 may be configured to, for example, perform transmitting, to a UE, control signaling that indicates the use of DFT-s-OFDM for an uplink shared channel in a radio frequency spectrum band, the radio frequency spectrum band including a plurality of frequency resources; transmitting, to the UE, DCI signaling that includes a bitmap allocating one or more frequency resources of the plurality of frequency resources of the radio frequency spectrum band for the uplink shared channel, one or more remaining frequency resources of the plurality of frequency resources for SRS signals; and receiving, from the UE, uplink shared channel signals and SRSs on the plurality of frequency resources according to the transmitted DCI signaling.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A baseband processor, comprising:
at least one processor core; and
memory coupled with the at least one processor core, the memory storing instructions that when executed by the at least one processor core cause the baseband processor to at least:
receive control signaling that indicates a sounding reference signal (SRS) configuration of a plurality of SRS ports associated with a plurality of antenna ports of a user equipment (UE) configured for performing antenna switching using the plurality of antenna ports, the SRS configuration identifying at least a first SRS resource and a second SRS resource;
provide SRSs for transmission via the plurality of antenna ports using at least the first SRS resource and the second SRS resource; and
generate a control message for transmission that includes one or more power headroom reports that indicate a first power value for the first SRS resource and a second power value of the second SRS resource.

2. The baseband processor of claim 1, wherein:
a difference between the first power value and the second power value indicates an insertion loss difference between different antenna ports of the plurality of antenna ports.

3. The baseband processor of claim 1, wherein:
the first power value for the first SRS resource or the second power value for the second SRS resource are for two or more antenna ports of the plurality of antenna ports.

4. The baseband processor of claim 1, wherein:
the control message comprises a media access control (MAC) control element that comprises a first power headroom report that indicates the first power value for the first SRS resource and a second power headroom report that indicates the second power value for the second SRS resource.

5. The baseband processor of claim 1, wherein:
the one or more power headroom reports comprise a power headroom report that indicates a first maximum transmission power for the first SRS resource, a second maximum transmission power for the second SRS resource, and a single power headroom value for both the first SRS resource and the second SRS resource.

6. The baseband processor of claim 1, wherein:
the one or more power headroom reports comprise a power headroom report that indicates a first power headroom value for the first SRS resource, a second power headroom value for the second SRS resource, and a single maximum transmission power for both the first SRS resource and the second SRS resource.

7. The baseband processor of claim 1, wherein:
the one or more power headroom reports comprise a power headroom report that indicates a first power headroom value and a first maximum transmission power for the first SRS resource, and indicates a second power headroom value and a second maximum transmission power for the second SRS resource.

8. The baseband processor of claim 1, wherein:
the one or more power headroom reports comprise a first maximum transmission power reduction for the first SRS resource, and a second maximum transmission power reduction for the second SRS resource.

9. The baseband processor of claim 1, wherein:
the one or more power headroom reports comprise a power headroom report that indicates a single maximum transmission power reduction for both the first SRS resource and the second SRS resource.

10. The baseband processor of claim 1, wherein:
the one or more power headroom reports comprises a first power headroom report and a second power headroom report, wherein the first power headroom report indicates the first power value for the first SRS resource, the second power headroom report indicates the second power value for the second SRS resource, and the first power value is independently encoded from the second power value.

11. The baseband processor of claim 1, wherein:
the one or more power headroom reports comprises a first power headroom report and a second power headroom report, wherein the first power headroom report indicates the first power value for the first SRS resource, the second power headroom report indicates the second power value for the second SRS resource, and the first power value is differentially encoded relative to the second power value.

12. The baseband processor of claim 1, wherein:
the one or more power headroom reports are generated for transmission in a UE assistance information message via radio resource control signaling.

13. The baseband processor of claim 1, further comprising:
generating, for transmission to a network entity, control signaling indicating a capability of the UE to maintain a same phase for SRS transmissions for a phase continuity window.

14. The baseband processor of claim 1, further comprising:
receiving, from a network entity, control signaling identifying a phase continuity window during which the UE is to maintain a same precoder and a same phase for SRS transmissions, the phase continuity window applicable to periodic or semi-persistent SRS transmissions.

15. The baseband processor of claim 14, wherein:
a switch between an uplink data transmission and a downlink data reception within the phase continuity window releases the UE from maintaining the same phase for SRS transmissions.

16. The baseband processor of claim 14, further comprising:
maintaining one or both of a same SRS transmission power within the phase continuity window or a same spatial relation within the phase continuity window.

17. The baseband processor of claim 1, further comprising:
receiving control signaling that indicates the use of discrete Fourier transform spread orthogonal frequency division multiplexing for an uplink shared channel in a radio frequency spectrum band; and
receiving downlink control information (DCI) signaling that includes a bitmap allocating frequency resources of the radio frequency spectrum band for the uplink shared channel.

18. The baseband processor of claim 1, further comprising:
receiving control signaling that indicates the use of discrete Fourier transform spread orthogonal frequency division multiplexing for an uplink shared channel in a radio frequency spectrum band; and
receiving downlink control information (DCI) signaling that includes at least a first bitmap allocating a first set of frequency resources of the radio frequency spectrum band for the uplink shared channel in a first one or more symbols of a slot, and a second bitmap allocating a second set of frequency resources of the radio frequency spectrum band for the uplink shared channel in a second one or more symbols of the slot.

19. A method of wireless communication at a user equipment (UE), comprising:
transmitting, to a network entity, control signaling indicating a capability of the UE to maintain a same phase for sounding reference signal (SRS) transmissions for a time duration of a phase continuity window;
receiving, from the network entity and at least in part in response to the transmitted control signaling, an indication of the time duration of the phase continuity window during which the UE is to maintain the same phase for SRSs; and
transmitting SRSs according to the phase continuity window.

20. A method of wireless communication at a network entity, comprising:
transmitting, to a user equipment (UE), control signaling that indicates the use of discrete Fourier transform spread orthogonal frequency division multiplexing for an uplink shared channel in a radio frequency spectrum band, the radio frequency spectrum band including a plurality of frequency resources;
transmitting, to the UE, downlink control information (DCI) signaling that includes a bitmap allocating one or more frequency resources of the plurality of frequency resources of the radio frequency spectrum band for the uplink shared channel, one or more remaining frequency resources of the plurality of frequency resources for sounding reference signals (SRSs); and
receiving, from the UE, uplink shared channel signals and SRSs on the plurality of frequency resources according to the transmitted DCI signaling.
